(19) United States
(12) Patent Application Publication
(10) Pub. No.: US 2011/0178694 A1
(43) Pub. Date: Jul. 21, 2011

(54) CONTROL DEVICE FOR VARIABLE VALVE ACTUATION SYSTEM

(75) Inventor: TOKIJI ITO, TOYOTA-SHI (JP)

(73) Assignee: TOYOTA JIDOSHA KABUSHIKI KAISHA, TOYOTA-SHI (JP)

(21) Appl. No.: 13/004,435

(22) Filed: Jan. 11, 2011

(30) Foreign Application Priority Data
Jan. 21, 2010 (JP) 2010-011109

(51) Int. Cl. F02D 41/00; F01L 1/34

(52) U.S. Cl. 701/103; 123/90.15

(57) ABSTRACT

A control device for a variable valve actuation system includes: an engine valve; a variable valve actuation mechanism that variably controls a valve timing of the engine valve and at least one of a valve operating angle and valve lift of the engine valve; a variable setting unit that variably sets a control range, in which at least one of the valve operating angle and the valve lift is controlled by the variable valve actuation mechanism, on the basis of the valve timing; a detecting unit that detects a plurality of valve timings of the engine valve in different modes in such a manner that the control range is changed; and a control range setting unit that variably sets the control range using one of the plurality of detected valve timings.

### INCORPORATION BY REFERENCE

The disclosure of Japanese Patent Application No. 2010-011109 filed on Jan. 21, 2010 including the specification, drawings and abstract is incorporated herein by reference in its entirety.

### BACKGROUND OF THE INVENTION

1. Field of the Invention

The invention relates to a control device for a variable valve actuation system, which variably controls the valve timing of an engine valve and at least one of the valve operating angle and valve lift of the engine valve and variably sets the control range of at least one of the valve operating angle and the valve lift on the basis of the valve timing.

2. Description of the Related Art

A variable valve timing mechanism that is able to change the valve timing of an engine valve (intake or exhaust valve) is practically used as a mechanism equipped for, for example, a vehicle-mounted internal combustion engine. In an internal combustion engine that includes such a variable valve timing mechanism, the valve timing of an engine valve is regulated on the basis of an engine operating condition to thereby make it possible to improve performance, such as fuel economy, output and emission.

FIG. 4 shows an example of such a variable valve timing mechanism. The variable valve timing mechanism shown in the drawing includes two rotary bodies, that is, a vane rotor 20 and a housing 1. The vane rotor 20 is fixed to a camshaft of the internal combustion engine so as to be integrally rotatable. In addition, a plurality of vanes 22 are formed on the outer periphery of the vane rotor 20 so as to radially protrude from the vane rotor 20.

On the other hand, the housing 21 is fixed to a cam pulley 23 so as to be integrally rotatable. The cam pulley 23 is drivably coupled to a crankshaft, which is an engine output shaft, via a timing belt, and rotates in synchronization with the crankshaft. The housing 21 fixed to the cam pulley 23 is formed in a substantially annular shape, and a plurality of recesses that respectively accommodate the vanes 22 are formed on the inner periphery of the housing 21. Two spaces are defined in each of the recesses 24 by a corresponding one of the vanes 22. The two spaces are a retard oil chamber 25 and an advance oil chamber 26. The retard oil chamber 25 is formed on a preceding side of the vane 22 in the camshaft rotation direction. The advance oil chamber 26 is formed on the opposite side of the vane 22.

The thus configured variable valve timing mechanism rotates the vane rotor 20 with respect to the housing 21 by hydraulic pressure supplied to the retard oil chambers 25 or the advance oil chambers 26 to thereby change the valve timing of the engine valve.

For example, when hydraulic pressure is supplied to the retard oil chambers 25 and hydraulic pressure is drawn from the advance oil chambers 26, the vanes 22 are urged in the counter rotation direction of the camshaft (retard direction) by the hydraulic pressure in the retard oil chambers 25, and then the vane rotor 20 is rotated in the retard direction with respect to the housing 21. As the vane rotor 20 is relatively rotated in the retard direction, the camshaft is also rotated in the retard direction with respect to the cam pulley 23 and, as a result, the valve timing of the engine valve is retarded.

On the other hand, when hydraulic pressure is supplied to the advance oil chambers 26 and hydraulic pressure is drawn from the retard oil chambers 25, the vanes 22 are urged in the rotation direction of the camshaft (advance direction) by the hydraulic pressure in the advance oil chambers 26, and then the vane rotor 20 is rotated in the advance direction with respect to the housing 21. As the vane rotor 20 is relatively rotated in the advance direction, the camshaft is also rotated in the advance direction with respect to the cam pulley 23 and, as a result, the valve timing of the engine valve is advanced.

The valve timing of the engine valve, which is variably changed by the variable valve timing mechanism, is, for example, detected in a mode described in Japanese Patent Application Publication No. 2001-263117 (JP-A-2001-263117). That is, in JP-A-2001-263117, a reference operating position of the variable valve timing mechanism is learned and then the valve timing is detected using a displacement of a relative operating position of the variable valve timing mechanism with respect to the learned reference operating position.

More specifically, in JP-A-2001-263117, in a state where the variable valve timing mechanism has been driven to a most retarded operating position, a deviation between a reference position and a rotation angle (cam angle) of the camshaft, detected using a signal from a cam angle sensor, is obtained, and then a value calculated from the deviation is used as a learned value of the reference operating position. Then, thereafter, a displacement of the vane rotor 20 from the learned reference operating position is used as an index value of the valve timing.

In addition, in recent years, a variable valve lift/valve operating angle mechanism that is able to change the valve operating angle or valve lift of the engine valve is practically used. In an internal combustion engine that includes the variable valve lift/valve operating angle mechanism and the variable valve timing mechanism, when the valve operating angle or the valve lift is increased in a state where the valve timing is set so that the valve lift center approaches a piston top dead center, the engine valve may interfere with the piston, that is, so-called valve stamp may occur.

In a control device for a variable valve actuation system described in Japanese Patent Application Publication No. 2006-029159 (JP-A-2006-029159), when an estimated valve timing exceeds a predetermined value, the valve timing or the valve lift is changed so as to avoid valve stamp, thus avoiding valve stamp.

Even with the method described in JP-A-2006-029159, indeed, it is possible to avoid valve stamp if an accurate valve timing may be detected. However, the reference operating position of the variable valve timing mechanism may possibly be erroneously learned because of stuck foreign matter, a failure of the variable valve timing mechanism, or the like. In such a case, it may be difficult to appropriately avoid valve stamp. That is, when the valve timing is erroneously detected as a value that is more retarded than an actual value as a result of erroneous learning, it may be erroneously recognized that the valve timing is still in a safe region even in a region in which valve stamp occurs, so there is a possibility that the valve timing or the valve lift is not changed to avoid valve stamp and, as a result, this leads to valve stamp.

### SUMMARY OF INVENTION

The invention provides a control device for a variable valve actuation system, which is able to further reliably avoid valve stamp.

An aspect of the invention relates to a control device for a variable valve actuation system. The control device for a variable valve actuation system includes: an engine valve; a variable valve actuation mechanism that variably controls a valve timing of the engine valve and at least one of a valve operating angle and valve lift of the engine valve; a variable setting unit that variably sets a control range, in which at least one of the valve operating angle and the valve lift is controlled by the variable valve actuation mechanism, on the basis of the valve timing; a detecting unit that detects a plurality of valve timings of the engine valve in different modes in such a manner that the control range is changed; and a control range setting unit that variably sets the control range using one of the plurality of detected valve timings.

In the above aspect, the control range setting unit may variably set the control range using one of the plurality of detected valve timings, of which a valve lift center is closest to a piston top dead center.

With the above configuration, even when any one of the plurality of detected valve timings is erroneously detected as a value of which a valve lift center is remote from a piston top dead center as compared with an actual value, the control range of the valve operating angle or the valve lift is set using another one of the detected valve timings. In addition, when any one of the plurality of detected valve timings is erroneously detected as a value of which a valve lift center is close to a piston top dead center as compared with an actual value, the control range of the valve operating angle or the valve lift is set using that value. In this case, although the control range is intrinsically unnecessarily limited, safer measures are taken in terms of avoidance of valve stamp. Therefore, valve stamp may be further reliably avoided.

In addition, in the above aspect, the engine valve may be an intake valve, and the control range setting unit may variably set the control range using most advanced one of the plurality of detected valve timings.

With the above configuration, even when any one of the plurality of detected valve timings is erroneously detected as a value that is more retarded as compared with an actual value, the control range of the valve operating angle or the valve lift is set using more advanced one of the detected valve timings. In addition, when any one of the plurality of detected valve timings is erroneously detected as a value that is more advanced as compared with an actual value, the control range of the valve operating angle or the valve lift is set using that value. In this case, although the control range is intrinsically unnecessarily limited, safer measures are taken in terms of avoidance of valve stamp. Therefore, valve stamp may be further reliably avoided.

The control device may further include a learning unit that learns a reference operating position of the variable valve actuation mechanism, wherein the detecting unit may include a first detecting unit that detects the valve timing as a relative value of an operating position of the variable valve actuation mechanism with reference to the reference operating position and a second detecting unit that detects the valve timing as an absolute value based on an output timing of a signal of a cam angle sensor that outputs a signal at a prescribed cam angle, and the control range setting unit may variably set the control range using one of the valve timing detected by the first detecting unit and the valve timing detected by the second detecting unit, of which a valve lift center is closer to a piston top dead center.

With the above configuration, even when any one of the valve timings detected by the first and second detecting units is erroneously detected as a value of which a valve lift center is remote from a piston top dead center as compared with an actual value, the control range of the valve operating angle or the valve lift is set using the other one of the detected valve timings. In addition, when any one of the detected valve timings is erroneously detected as a value of which a valve lift center is close to a piston top dead center as compared with an actual value, the control range of the valve operating angle or the valve lift is set using that value. In this case, although the control range is intrinsically unnecessarily limited, safer measures are taken in terms of avoidance of valve stamp. Therefore, valve stamp may be further reliably avoided.

The control device may further include a learning unit that learns a reference operating position of the variable valve actuation mechanism, wherein the engine valve may be an intake valve, the detecting unit may include a first detecting unit that detects the valve timing as a relative value of an operating position of the variable valve actuation mechanism with reference to the reference operating position and a second detecting unit that detects the valve timing as an absolute value based on an output timing of a signal of a cam angle sensor that outputs a signal at a prescribed cam angle, and the control range setting unit may variably set the control range using more advanced one of the valve timing detected by the first detecting unit and the valve timing detected by the second detecting unit.

With the above configuration, even when any one of the valve timings detected by the first and second detecting units is erroneously detected as a value that is more retarded as compared with an actual value, the control range of the valve operating angle or the valve lift is set using the other more advanced one of the valve timings. In addition, when any one of the detected valve timings is erroneously detected as a value that is more advanced as compared with an actual value, the control range of the valve operating angle or the valve lift is set using that value. In this case, although the control range is intrinsically unnecessarily limited, safer measures are taken in terms of avoidance of valve stamp. Therefore, valve stamp may be further reliably avoided.

### BRIEF DESCRIPTION OF DRAWINGS

The features, advantages, and technical and industrial significance of this invention will be described below with reference to the accompanying drawings, in which like numerals denote like elements, and wherein:

FIG. 1 is a schematic view that shows the configuration of an internal combustion engine to which a control device for a variable valve actuation system according to an embodiment is applied and also shows the control system of the internal combustion engine;

FIG. 2 is a graph that shows the relationship between a valve timing and a stamp prevention guard value in a stamp prevention guard value calculation map used in the embodiment;

FIG. 3 is a flowchart that shows the procedure in a stamp prevention guard value calculation routine used in the embodiment; and

FIG. 4 is a cross-sectional view that shows the front cross-sectional structure of an example of a variable valve timing mechanism used in a variable valve actuation system in a related technical field.

### DETAILED DESCRIPTION OF EMBODIMENTS

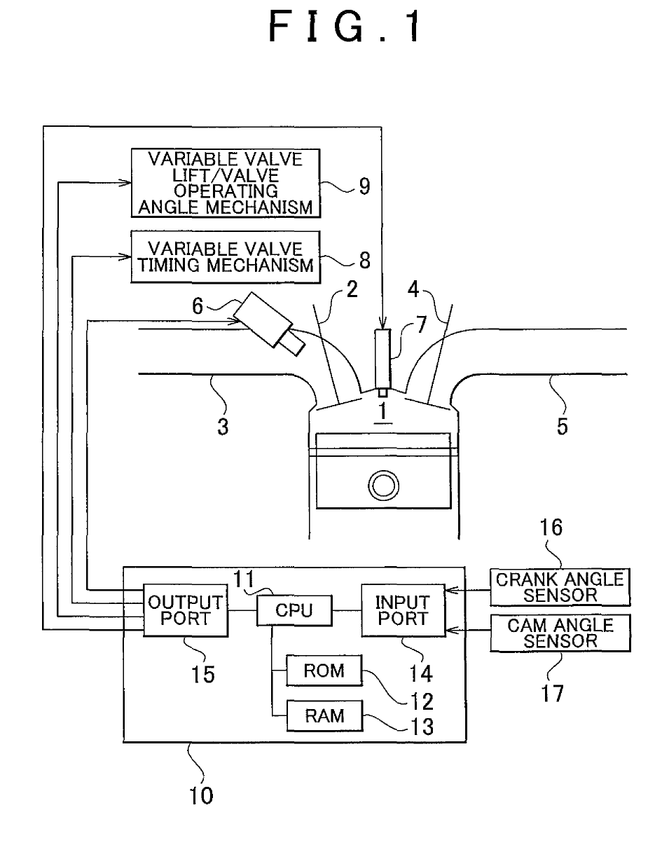

Hereinafter, a control device for a variable valve actuation system according to an embodiment of the invention will be described in detail with reference to FIG. 1 to FIG. 3. FIG. 1 shows the configuration of an internal combustion engine to which the control device for a variable valve actuation system according to the embodiment is applied and also shows the control system of the internal combustion engine.

A combustion chamber 1 of the internal combustion engine according to the embodiment is coupled to an intake pipe 3 via an intake valve 2, and is coupled to an exhaust pipe 5 via an exhaust valve 4. An injector 6 is provided for the intake pipe 3. The injector 6 injects fuel into intake air flowing through the intake pipe 3. In addition, an ignition plug 7 is provided in the combustion chamber 1. The ignition plug 7 ignites a mixture of air and fuel introduced into the combustion chamber 1.

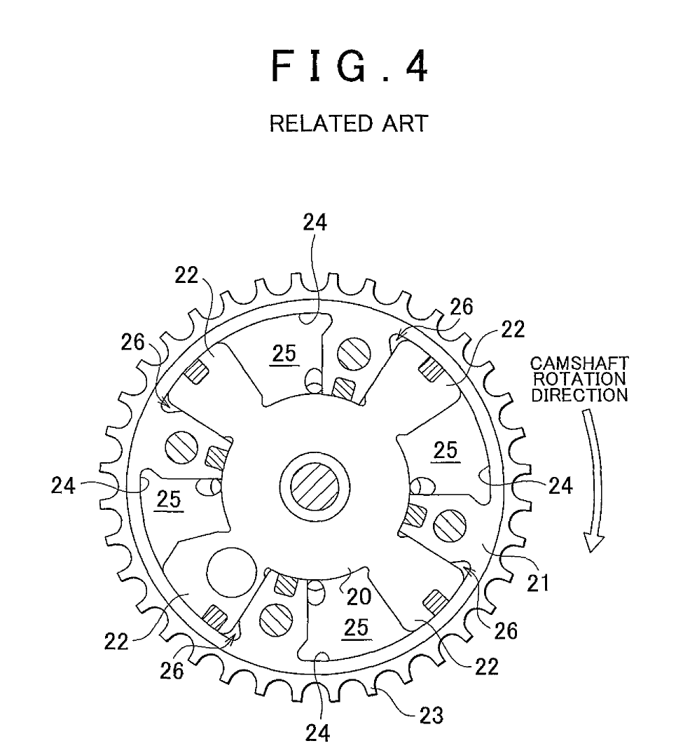

In a valve actuation system for the intake valve 2 of the thus configured internal combustion engine, a variable valve timing mechanism 8 and a variable valve lift/valve operating angle mechanism 9 are provided. The variable valve timing mechanism 8 is able to change the valve timing of the intake valve 2. The variable valve lift/valve operating angle mechanism 9 is able to change the valve operating angle and valve lift of the intake valve 2. Note that the variable valve timing mechanism 8 employed in the present embodiment has the same configuration as that of FIG. 4.

The thus configured internal combustion engine is controlled by an electronic control unit 10. The electronic control unit 10 includes a central processing unit (CPU) 11, a read only memory (ROM) 12, a random access memory (RAM) 13, an input port 14 and an output port 15. The CPU 11 carries out various types of processing in connection with engine control, and the ROM 12 stores programs and data for engine control. In addition, the RAM 13 temporarily stores the results processed by the CPU 11 and the results detected by sensors.

The electronic control unit 10 receives detection data from sensors of various portions of the vehicle via the input port 14. For example, the electronic control unit 10 receives detection data of a crank angle sensor 16, a cam angle sensor 17, and the like, via the input port 14. The crank angle sensor 16 outputs a pulse signal at an interval of a constant rotation angle of a crankshaft. The cam angle sensor 17 outputs a signal at a prescribed rotation angle of an intake camshaft.

In addition, the electronic control unit 10 outputs a command to various portions of the vehicle via the output port 15. For example, the electronic control unit 10 outputs a command to a driving circuit of the injector 6, the ignition plug 7, the variable valve timing mechanism 8, the variable valve lift/valve operating angle mechanism 9, or the like, via the output port 15.

In the thus configured internal combustion engine, the electronic control unit 10 detects the valve timing of the intake valve 2, which may be changed by the variable valve timing mechanism 8, in the following two modes.

1. Detection of Valve Timing Using Relative Value with Reference to Reference Operating Position

At the time of an engine start, or the like, the electronic control unit 10 drives the variable valve timing mechanism 8 to a most retarded operating position, that is, a position at which a vane rotor 20 contacts side walls of recesses 24 in a retard direction (see FIG. 4). Then, in that state, a rotation angle (cam angle) of the camshaft, detected using a signal from the cam angle sensor is learned as a most retarded learned value. Thereafter, the electronic control unit 10 detects a deviation between a current cam angle at a signal output timing of the cam angle sensor 17 and the most retarded learned value, that is, an advance of the vane rotor 20 from the most retarded position to thereby obtain that value as a first valve timing detected value evt.

2. Detection of Valve Timing Using Absolute Value based on Signal Output Timing of Cam Angle Sensor

When the valve timing of the intake valve 2 is advanced by the above described variable valve timing mechanism 8, the rotation angle (cam angle) of the intake camshaft advances, so the output timing of a signal from the cam angle sensor 17 becomes earlier. In addition, when the valve timing of the intake valve 2 is retarded by the variable valve timing mechanism 8, the rotation angle (cam angle) of the intake camshaft retards, so the output timing of a signal from the cam angle sensor 17 delays. Then, the electronic control unit 10 calculates the valve timing of the intake valve 2 from the output timing of a signal from the cam angle sensor 17 as an absolute value, and then sets the calculated value as a second valve timing detected value gavtb.

Note that the output timing of a signal from the cam angle sensor 17 varies because of an assembling tolerance of the intake camshaft, or the like, so the second valve timing detected value gavtb contains a certain error. Then, the electronic control unit 10 uses the first valve timing detected value evt to control the variable valve timing mechanism 8.

Incidentally, in the internal combustion engine that includes the variable valve timing mechanism 8 and the variable valve lift/valve operating angle mechanism 9, when the valve operating angle or the valve lift is increased in a state where the valve timing of the intake valve 2 is advanced, the intake valve 2 may interfere with a piston, that is, so-called valve stamp may occur. The valve stamp occurs at a smaller valve operating angle or valve lift as the valve timing of the intake valve 2 is advanced and then the valve lift center approaches the piston top dead center.

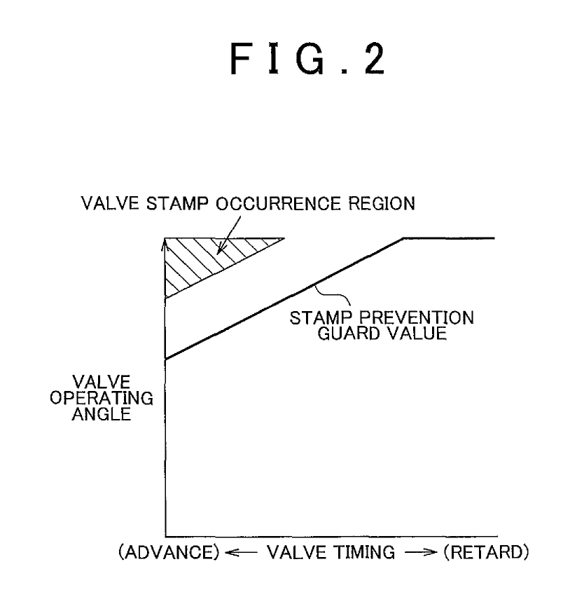

Then, in the present embodiment, an upper limit of the valve operating angle, at which it is possible to reliably avoid valve stamp, is calculated from a current valve timing as a stamp prevention guard value, and then the control range of the valve operating angle of the intake valve 2 is limited within the range below the calculated stamp prevention guard value. By so doing, valve stamp is avoided. The electronic control unit 10 calculates a stamp prevention guard value using the calculation map shown in FIG. 2. As shown in the drawing, a stamp prevention guard value is set at a smaller value as the valve timing is advanced.

Here, it is important what value is used as the valve timing used to calculate a stamp prevention guard value. The above first valve timing detected value evt may possibly take an inappropriate value because of erroneous learning of a most retarded learned value, or the like. Erroneous learning of a most retarded learned value occurs, for example, when the vane rotor 20 stops before the most retarded position because of stuck foreign matter, or the like, when the variable valve timing mechanism 8 is driven to the most retarded position for learning. In addition, the second valve timing detected value gavtb originally contains an error and may take an inappropriate value because of a failure, or the like. That is, both the first valve timing detected value evt and the second valve timing detected value gavtb may cause erroneous detection.

Here, if the valve timing used to calculate a stamp prevention guard value is a value that is more retarded than an actual value, the stamp prevention guard value is set at a value larger than an intrinsically required value. In such a case, sufficient guard cannot be achieved, so there is a possibility that the valve operating angle of the intake valve 2 falls within a valve stamp occurrence region.

Then, in the present embodiment, even when any one of the first valve timing detected value evt and the second valve timing detected value gavtb is erroneously detected, a stamp prevention guard value is calculated in the following mode in order to reliably avoid valve stamp. That is, in the present embodiment, the electronic control unit 10 calculates a stamp prevention guard value using one of the first valve timing detected value evt and the second valve timing detected value gavtb, of which the valve lift center is close to the piston top dead center, that is, in this case, using more advanced one of the first valve timing detected value evt and the second valve timing detected value gavtb.

Here, it is assumed when any one of the first valve timing detected value evt and the second valve timing detected value gavtb is more retarded than an actual value. At this time, the electronic control unit 10 uses an appropriate valve timing detected value that is more advanced than the other to calculate a stamp prevention guard value. Thus, in this case as well, it is possible to avoid valve stamp.

Next, it is assumed that any one of the first valve timing detected value evt and the second valve timing detected value gavtb is more advanced than an actual value. At this time, the electronic control unit 10 uses an erroneous valve timing detected value that is more advanced than the other to calculate a stamp prevention guard value. In this case, the stamp pretension guard value is set at a value that is smaller than an intrinsically required value, so the control range of the valve operating angle is limited more than necessary. However, in terms of avoidance of valve stamp, safer measures are taken.

In this way, in the present embodiment, even when any one of the first valve timing detected value evt and the second valve timing detected value gavtb is erroneously detected, it is possible to reliably avoid valve stamp.

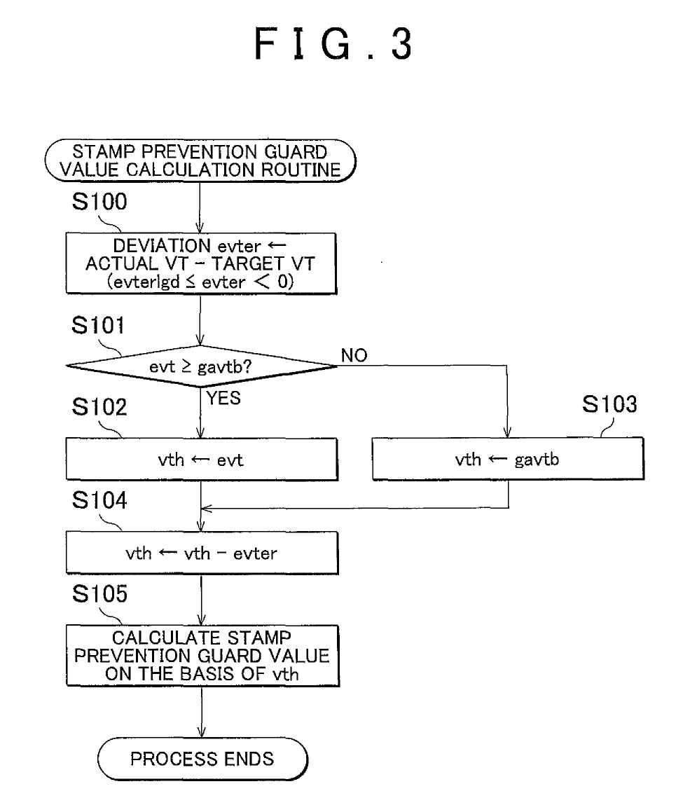

FIG. 3 shows the flowchart of a stamp prevention guard value calculation routine used in the present embodiment. The process of this routine is repeatedly executed by the electronic control unit 10 at prescribed control intervals.

As the routine is started, a deviation evter between a target valve timing and an actual valve timing is initially calculated in step 5100. The deviation evter is calculated so that a value obtained by subtracting the target valve timing from the actual valve timing is limited to fall within the range larger than or equal to a constant evterlgd that takes a negative value (for example, “−10”) and smaller than or equal to “0”.

In subsequent step S101, it is determined whether the first valve timing detected value evt is larger than or equal to the second valve timing detected value gavtb. Here, when the first valve timing detected value evt is larger than or equal to the second valve timing detected value gavtb (S101: YES), that is, when the first valve timing detected value evt is more advanced than the second valve timing detected value gavtb, the first valve timing detected value evt is substituted into a valve timing vth for calculating a guard value in step S102.

On the other hand, when the first valve timing detected value evt is smaller than the second valve timing detected value gavtb (S101: NO), that is, when the second valve timing detected value gavtb is more advanced than the first valve timing detected value evt, the second valve timing detected value gavtb is substituted into a valve timing vth for calculating a guard value in step S103.

When substitution of the value into the valve timing vth for calculating a guard value is complete, the valve timing vth for calculating a guard value is updated into the value obtained by subtracting the deviation evter from the valve timing vth in subsequent step S104. Then, in the next step S105, a stamp prevention guard value is calculated on the basis of the updated valve timing vth for calculating a guard value by referring to the calculation map (FIG. 2).

Note that the deviation evter takes a negative value when the target valve timing is more advanced than the actual valve timing and the valve timing is being changed in an advance direction. Then, in this case, the stamp prevention guard value is reduced in expectation of an advance of the valve timing thereafter to thereby make it possible to reliably avoid valve stamp.

In the present embodiment, the electronic control unit 10 executes processes performed by a learning unit, a first detecting unit and a second detecting unit. In addition, in the present embodiment, the first valve timing detected value evt corresponds to a valve timing detected by the first detecting unit, and the second valve timing detected value gavtb corresponds to a valve timing detected by the second detecting unit.

With the above described control device for a variable valve actuation system according to the present embodiment, the following advantageous effects may be obtained. In the present embodiment, the electronic control unit 10 leans the reference operating position (most retarded position) of the variable valve timing mechanism 8, and calculates the first valve timing detected value evt as a relative value of the operating position of the variable valve timing mechanism 8 with reference to the most retarded position. In addition, the electronic control unit 10 also calculates the second valve timing detected value gavtb as an absolute value based on the output timing of a signal of the cam angle sensor 17. Then, the electronic control unit 10 uses more advanced one of the first valve timing detected value evt and the second valve timing detected value gavtb, that is, a value at which the valve lift center is closer to the piston top dead center, to calculate a stamp prevention guard value to thereby variably set the control range of the valve operating angle of the intake valve 2. In the thus configured present embodiment, even when any one of the first valve timing detected value evt and the second valve timing detected value gavtb is erroneously detected as a value that is more retarded than an actual value, the other more advanced valve timing detected value is used to set the control range of the valve operating angle of the intake valve 2. In addition, when any one of the above two valve timing detected values is erroneously detected as a value that is more advanced than an actual value, that value is used to set the control range of the valve operating angle or the valve lift. In this case, intrinsically unnecessary limitation is imposed on the control range; however, in terms of avoidance of valve stamp, safer measures are taken. Therefore, with the control device for a variable valve actuation system according to the present embodiment, it is possible to further reliably avoid valve stamp.

Note that the above embodiment may be modified into the following alternative embodiments. In the above embodiment, a stamp prevention guard value is calculated using a value that is obtained by subtracting a deviation evter from more advanced one of the first valve timing detected value evt and the second valve timing detected value gavtb. Then, by so doing, even when the valve timing is being advanced, valve stamp may be reliably avoided. However, when a change in valve timing during a calculation cycle of a stamp prevention guard value is sufficiently small, it is applicable that a deviation evter is not subtracted from the valve timing but more advanced one of the first valve timing detected value evt and the second valve timing detected value gavtb is directly used to calculate a stamp prevention guard value.

In the above embodiment, the reference operating position of the variable valve timing mechanism 8 is set to the most retarded position; however, as long as the operating position of the variable valve timing mechanism 8 is a determinable operating position not by detection, such as a most advanced position, an operating position other than the most retarded position may be set for the reference operating position.

In the above embodiment, two valve timing detected values, that is, the first valve timing detected value evt and the second valve timing detected value gavtb, are used to calculate a stamp prevention guard value. Note that the valve timing may be detected in a mode that is different from any of the modes in which the above two valve timing detected values are detected, and then the thus detected valve timing detected value other than the above two is conceivably used to calculate a stamp prevention guard value. In such a case as well, most advanced one of a plurality of valve timing detected values detected in different modes is used to calculate a stamp prevention guard value, that is, to variably set the control range of the valve operating angle of the intake valve 2, it is possible to reliably avoid valve stamp.

In the above embodiment, the valve timing of the intake valve 2 and the valve operating angle and valve lift of the intake valve 2 are variably controlled; however, the aspect of the invention may also be applied to a case where the valve timing of the exhaust valve 4 and the valve operating angle and valve lift of the exhaust valve 4 are variably controlled. In the case of the exhaust valve 4, as the valve timing is retarded, the valve lift center of the exhaust valve 4 approaches the piston top dead center. Thus, in such a case, it is only necessary that most retarded one of a plurality of valve timing detected values detected in different modes is used to calculate a stamp prevention guard value.

In the above embodiment, the variable valve lift/valve operating angle mechanism 9 is controlled using the valve operating angle as a controlled variable; instead, the variable valve lift/valve operating angle mechanism 9 may be controlled using the valve lift of the engine valve as a controlled variable. In such a case, a stamp prevention guard value is set for the valve lift.

The variable valve lift/valve operating angle mechanism 9 according to the present embodiment variably controls both the valve operating angle and the valve lift; however, the aspect of the invention may also be similarly applied to a variable valve actuation system in which the variable mechanism is able to change only the valve operating angle or only the valve lift.

What is claimed is:

1. A control device for a variable valve actuation system, comprising:
an engine valve;
a variable valve actuation mechanism that variably controls a valve timing of the engine valve and at least one of a valve operating angle and valve lift of the engine valve;
a variable setting unit that variably sets a control range, in which at least one of the valve operating angle and the valve lift is controlled by the variable valve actuation mechanism, on the basis of the valve timing;
a detecting unit that detects a plurality of valve timings of the engine valve in different modes in such a manner that the control range is changed; and
a control range setting unit that variably sets the control range using one of the plurality of detected valve timings.

2. The control device for a variable valve actuation system according to claim 1, wherein the control range setting unit variably sets the control range using one of the plurality of detected valve timings, of which a valve lift center is closest to a piston top dead center.

3. The control device for a variable valve actuation system according to claim 1, wherein:
the engine valve is an intake valve; and
the control range setting unit variably sets the control range using most advanced one of the plurality of detected valve timings.

4. The control device for a variable valve actuation system according to claim 1, further comprising:
a learning unit that learns a reference operating position of the variable valve actuation mechanism, wherein
the detecting unit detects one of the plurality of detected valve timings as a relative value of an operating position of the variable valve actuation mechanism with reference to the reference operating position.

5. The control device for a variable valve actuation system according to claim 1, wherein the detecting unit detects one of the plurality of detected valve timings as an absolute value based on an output timing of a signal of a cam angle sensor that outputs a signal at a prescribed cam angle.

6. The control device for a variable valve actuation system according to claim 2, further comprising:
a learning unit that learns a reference operating position of the variable valve actuation mechanism, wherein:
the detecting unit includes a first detecting unit that detects the valve timing as a relative value of an operating position of the variable valve actuation mechanism with reference to the reference operating position and a second detecting unit that detects the valve timing as an absolute value based on an output timing of a signal of a cam angle sensor that outputs a signal at a prescribed cam angle; and
the control range setting unit variably sets the control range using one of the valve timing detected by the first detecting unit and the valve timing detected by the second detecting unit, of which a valve lift center is closer to a piston top dead center.

7. The control device for a variable valve actuation system according to claim 3, further comprising:
a learning unit that learns a reference operating position of the variable valve actuation mechanism, wherein:
the engine valve is an intake valve;
the detecting unit includes a first detecting unit that detects the valve timing as a relative value of an operating position of the variable valve actuation mechanism with reference to the reference operating position and a second detecting unit that detects the valve timing on the basis of an output timing of a signal of a cam angle sensor that outputs a signal at a prescribed cam angle; and
the control range setting unit variably sets the control range using more advanced one of the valve timing detected by the first detecting unit and the valve timing detected by the second detecting unit.

8. The control device for a variable valve actuation system according to claim 1, wherein:
the engine valve is an exhaust valve; and
the control range setting unit variably sets the control range using most retarded one of the plurality of detected valve timings.

9. The control device for a variable valve actuation system according to claim 1, wherein the control range setting unit sets an upper limit of the control range using one of the plurality of detected valve timings.
